(19) United States
(12) Patent Application Publication
(10) Pub. No.: US 2020/0154198 A1
(43) Pub. Date: May 14, 2020

(54) LOUDSPEAKER

(71) Applicant: Fraunhofer-Gesellschaft zur Foerderung der angewandten Forschung e.V., Munich (DE)

(72) Inventors: Martin SCHNEIDER, Erlangen (DE); Emanuel HABETS, Erlangen (DE); Stefan WETZEL, Erlangen (DE); Oliver HELLMUTH, Erlangen (DE); Peter PROKEIN, Erlangen (DE)

(21) Appl. No.: 16/740,303

(22) Filed: Jan. 10, 2020

Related U.S. Application Data
(63) Continuation of application No. PCT/EP2018/069016, filed on Jul. 12, 2018.

(30) Foreign Application Priority Data
Jul. 14, 2017 (EP) 17181479.1
Jan. 18, 2018 (EP) 18152311.9

(51) Int. Cl. H04R 1/34; H04R 1/02

(52) U.S. Cl. CPC H04R 1/345; H04R 2499/13; H04R 1/025

(57) ABSTRACT

A loudspeaker includes one or more drivers and at least two waveguides. The one or more drivers are arranged to emit soundwaves. The waveguides are coupled to the one or more drivers to receive the soundwaves emitted by the one or more drivers. The first of the at least two waveguides has an output position at a first position of the loudspeaker and is configured to forward the received soundwaves to the output at the first position, wherein a second of the at least two waveguides has an output position at a second position of the loudspeaker and is configured to forward the received soundwaves to the output at the second position.

### CROSS-REFERENCES TO RELATED APPLICATIONS

This application is a continuation of copending International Application No. PCT/EP2018/069016, filed Jul. 12, 2018, which is incorporated herein by reference in its entirety, and additionally claims priority from European Applications Nos. EP 17181479.1, filed Jul. 14, 2017, and EP 18152311.9, filed Jan. 18, 2018, all of which are incorporated herein by reference in their entirety.

### BACKGROUND OF THE INVENTION

Embodiments of the present invention refer to a loudspeaker. Preferred embodiments refer to loudspeaker beamforming by acoustic means.

In many applications, e.g., sound zones, sound-field reproduction, or adjustable directivity [1, 2, 3, 4], loudspeaker beamforming is used to control the direction in which reproduced sound is radiated. According to state-of-the-art, these techniques imply to use arrays of multiple loudspeakers, each equipped with an individual driver. Those drivers are supplied by separate signals, which typically implies to have the same number of digital-to-analog converters (DACs) and amplifiers. A DAC-amplifier-loudspeaker cascade will be referred to as reproduction channel in the following.

The lower frequency bound for effective directional reproduction is determined by the array aperture, i. e., the largest distance between two loudspeakers in the respective steering dimension. On the other hand, the upper frequency bound for controlled sound reproduction is imposed by aliasing. Aliasing occurs whenever the acoustic wavelength becomes smaller than two times the distance between two neighboring loudspeakers in the respective steering dimension. These two aspects imply that the distance between two neighboring loudspeakers have to be as short as possible, while there have to be loudspeakers with a distance as large as possible at the same time. Following both optimization goals implies to use a large number of reproduction channels. This problem becomes even more severe, when a steering in more than two dimensions is desired. Since each reproduction channel implies relatively high cost, the use of a large number of reproduction channels is not viable in the realm of consumer products. However, the use of many reproduction channels is still considered to be state of the art in beamforming (US2002012442A, US 2009060236A, U.S. Pat. No. 3,299,206).

In many cases, a beamformer receives a single input signal and works with static digital filters such that all loudspeaker signals are linearly dependent. Moreover, for certain classes of beamformers, such filters could also be realized by non-amplifying components. A well-known class fulfilling this property are delay-and-sum beamformers, which are, nevertheless, implemented using multiple reproduction channels with according implementation cost (US2004151325A, US2002131608). This problem can be mitigated by using passive components (in the realm of electronic circuits) driven by a single DAC-amplifier cascade as disclosed in US2013336505A. Still, realizing such a system involves a large number of individual loudspeaker drivers, which are known to be very expensive components.

An alternative to beamforming is to use directional loudspeakers, typically in form of horns (GB484704A), loudspeaker with special housings (EP3018915A1), exploiting a self-demodulating ultrasonic beam (US2004264707A, U.S. Pat. No. 4,823,908A), or very specific structures (U.S. Pat. No. 5,137,110A). Additionally, horn loudspeakers or similar transducers can be equipped with acoustic lenses (U.S. Pat. Nos. 3,980,829A, 2,519,771A). While these approaches provide a low-cost solution, they are rather limited in the choice of beam patterns and directions. In fact, the objective of those approaches is often only radiating normal to the loudspeaker aperture or achieving spherical radiation for a broad frequency range. Beside directional limitations, implementing those approaches typically involves a considerable volume of a given shape. This precludes using such approaches in electronic consumer products or in automotive applications, where space is a precious good and the shape of the built in components is often predetermined by the design of the exterior.

The US2003132056A describes a loudspeaker having multiple waveguides connected to a loudspeaker driver. Another patent publication in this context is the US2002014368A. Patent publication US2011211720A discloses to use isolated sound paths driven by a single driver.

Another patent publication in this context is the US2011019853A. There is state-of-the-art describing similar set of components, but in a different arrangement to treat the sound wave radiated from the rear side of a loudspeaker membrane (U.S. Pat. Nos. 4,553,628A, 5,025,886A). While U.S. Pat. No. 4,553,628A teaches to absorb the sound from the rear side, U.S. Pat. No. 5,025,886A teaches to radiate it in order to increase efficiency. Starting from the above described drawbacks, it is the object of the present invention to provide a simple and cost efficient approach enabling beamforming.

### SUMMARY

According to an embodiment, a loudspeaker may have: one or more drivers arranged to emit sound waves; at least two waveguides coupled to the one or more drivers to receive the sound waves emitted by the one or more drivers; wherein the first of the at least two waveguides has an output positioned at a first position of the loudspeaker and is configured to forward the received sound waves to the output at the first position, wherein a second of the at least two waveguides has an output positioned at a second position of the loudspeaker and is configured to forward the received sound waves to the output at the second position; wherein each of the at least two waveguides has a cross-sectional dimension which is smaller than the half of the wavelength of the sound waves to be transmitted and wherein a length of one of the at least two waveguides is at least as long as the half of the wavelength of the sound waves to be transmitted.

According to another embodiment, an automotive sound system may have an inventive loudspeaker.

Embodiments of the present invention provide a loudspeaker comprising one or more drivers and at least two waveguides. The one or more drivers are arranged to emit soundwaves, wherein the at least two waveguides are coupled to the one or more drivers to receive the soundwaves. The first of the at least two waveguides has an output positioned at a first position of the loudspeaker and is configured to forward the received soundwaves to the output, wherein a second of the at least two waveguides has an output position at a second position of the loudspeaker and is configured to forward the received soundwaves to the respective output. According to embodiments, the loudspeaker just comprises one (in terms of a single) driver, e.g., a pressure chamber driver, wherein an output of the pressure chamber is coupled to the at least two waveguides. According to embodiments, the coupling may be supported by a so-called acoustic splitter arranged between the one or more drivers and the at least two waveguides, wherein the acoustic splitter comprises one input and at least two outputs for the at least two waveguides and is configured to split the soundwaves received at its input to the two outputs. Preferably, the acoustic splitter performs the acoustic sealing such that the soundwaves are coupled into the waveguides optimally. Additionally, the acoustic splitter may be designed to enable a good impedance matching.

The teachings disclosed herein are based on the principle that a loudspeaker enabled for performing (acoustic) beamforming can be formed by a single sound source, e.g., a single driver or arrangement of drivers which emit commonly a sound signal (i.e., are driven by a common source signal) to a waveguide arrangement having at least two waveguides. The technical background is to realize according to embodiments a certain class of filter-and-sum-beamformers with purely acoustic means, i.e., mainly by accordingly designed waveguides. The waveguides may be formed by simple tubes of any solid material, like flexible tubes or PVC tubes and are configured to forward the received sound signal so as to distribute the soundwaves to different output positions. For this, according to the core idea, an acoustic wave is split and fed into the waveguides with accordingly chosen properties to outputs (outlets) which are arranged at specific positions. Due to the different sound emitting positions of the outputs/outlets and/or due to an influence of the waveguide to the transmitted soundwaves a beamforming of the sound emitted by a loudspeaker can be achieved. Thus, beamforming or, in general, directional audio reproduction can be realized by a loudspeaker having just a single loudspeaker driver. This approach allows for an inexpensive and flexible implementation of reproduction systems that would otherwise need a large number of expensive hardware components. It has been found out that the performance is comparable to a traditional delay-and-sum-beamformer with multiple loudspeakers but at a fraction of its costs.

It is assumed that more advanced waveguide designs, which will be discussed below, can further improve the performance, wherein the resulting design is flexible enough to be integrated in a large variety of consumer electronic products or in automotive applications.

Regarding the acoustic splitter, it should be mentioned that, according to embodiments, the acoustic splitter comprises one input and two or more outputs, wherein a cross-section of the of the splitter remains constant along a length of the splitter, i.e. the cross-section is at least as large as the output of the one or more drivers. When starting from the implementation of the driver as a pressure chamber loudspeaker having an output, this means that the cross-section area of the output of the pressure chamber loudspeaker is substantially equal to the sound cross-sections of the outputs. Note that there is typically one splitter per driver. When multiple drivers are used, multiple sets of waveguides will be used which are combined at the outputs.

According to further embodiments, the sound cross-sections of the plurality of waveguides are substantially equal to the cross-section area of the outlet of the loudspeaker driver. Such a design enables a good or sufficiently good acoustic matching between the waveguides and the loudspeaker driver. The result of the good acoustic matching is a high acoustic efficiency. According to further embodiments, the waveguide or, in particular, each of the at least two waveguides have a cross-sectional dimension which is smaller than the half of the wavelength of the soundwaves to the transmitted.

Regarding the waveguide, it should be mentioned that, according to embodiments, the first and the second waveguide are configured to forward the soundwaves in a delayed manner, such that the first of the at last two waveguides forwards the soundwaves with a first delay, wherein the second of the at least two waveguides forwards the soundwaves with a second delay, where the difference between the first delay and the second delay determines the achieved beam pattern. According to another embodiment, the delays could also be identical, depending on desired reproduction direction This design with regard to the delay may be achieved by designing the at least two waveguides, such that same have a length proportional to the respectively desired delay. According to embodiments, each length of the at least two waveguides is at least as long as the half of the wavelength of the soundwaves to be transmitted. Additionally, it should be noted that each waveguide is configured to vary the phase and/or the magnitude of the soundwaves to be forwarded as a result of the waveguide design.

According to further embodiments, each waveguide comprises at its output so-called output means enabling a matching of an acoustic impedance. According to embodiments, the output means may be formed by a horn-shaped element which is configured to match the acoustic impedance.

As discussed above, the first and second position differ from each other so as to form an array by the arrangement of the outputs of the at least two waveguides. According to further embodiments, the first position is spaced apart from the second position by a distance lower than the half of the wavelength of the soundwave to be forwarded. According to another embodiment, the loudspeaker comprises a third waveguide having an output at a third position and also configured to receive soundwaves and to forward same to its output. Optionally, the outputs of the at least three waveguides may be arranged so as to form a two-dimensional pattern.

According to another embodiment, each waveguide may be designed as acoustic filters, e.g., comprising a side channel or a feedback channel. This feature enables to improve the acoustic design just by means of varying the implementation of the waveguide.

### BRIEF DESCRIPTION OF THE DRAWINGS

Embodiments of the present invention will be detailed subsequently referring to the ap-pended drawings, in which:

FIG. 1 shows a schematic block diagram giving an overview over the individual (partially optional) components of the loudspeaker according to basic embodiments;

FIG. 2 shows a schematic illustration (longitudinal cut) of a loudspeaker according to a basic embodiment;

FIG. 3 shows a schematic implementation of a radiation pattern for a setup according to FIG. 2;

FIG. 4 shows a schematic illustration (longitudinal cut) of a loudspeaker according to another embodiment;

FIG. 5 shows a schematic radiation pattern for a setup according to FIG. 4;

FIG. 6 shows a schematic illustration (longitudinal cut) of a loudspeaker according to a further embodiment;

FIG. 7 shows a schematic radiation pattern for a setup according to FIG. 6;

FIG. 8 shows a schematic illustration (cross-sectional cut) of a waveguide enhanced by filter elements equivalent to a digital FIR filter according to a further embodiment;

FIG. 9 shows a schematic illustration (cross-sectional cut) of a waveguide enhanced by filter elements equivalent to a digital IIR filter according to further embodiments; and

FIGS. 10a-c show schematic illustrations of a prototype of a loudspeaker according to embodiments.

### DETAILED DESCRIPTION OF THE INVENTION

Embodiments will be subsequently discussed below referring to the enclosed figures, wherein identical reference numerals are provided to elements having identical or similar functions so that the description thereof is mutually applicable and interchangeable.

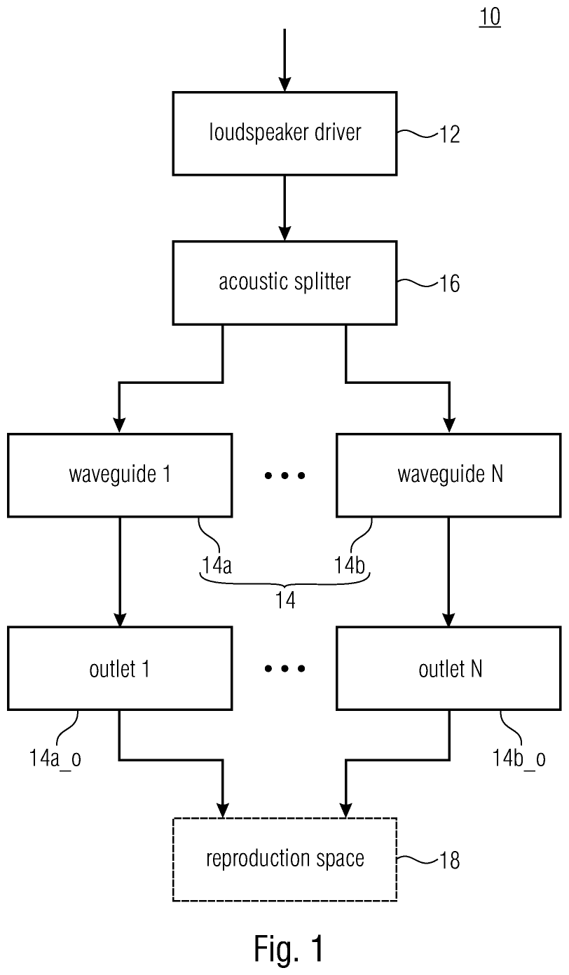

With respect to FIG. 1, a general overview over the inventive concept is given, wherein the components together with optional components of the loudspeaker 10 shown by FIG. 1 will be discussed below.

FIG. 1 shows a loudspeaker 10 comprising at least a loudspeaker driver 12 and at least two waveguides 14a and 14b. Each of the waveguides 14a and 14b may have an outlet 14a_o and 14b_o. The outlet 14a_o and 14b_o form the transition to the reproduction space which is marked by the reference numeral 18.

Optionally, between the two waveguides 14a and 14b and the loudspeaker 12 a so-called acoustic splitter 16 can be arranged. An alternative to an acoustic splitter can be to branch a single waveguide into multiple wave guides or another entity configured to split/distribute the acoustic wave.

The loudspeaker driver 12 can be a pressure chamber loudspeaker 12 or any other loudspeaker driver that can emit sound pressure to the inside of an enclosure that can be coupled to a waveguide arrangement 14 comprising the elements 14a and 14b. A pressure chamber loudspeaker driver 12 will be the choice for many applications as these drivers are originally designed to be connected to a waveguide 14 or, respectively, a horn as a representative of a waveguide.

The optional acoustic splitter 16 is coupled to the driver 12 in order to receive soundwaves (sound signal) generated by the driver 12 and a plurality of waveguide outputs by which the waveguides are coupled. In other words, the acoustic splitter 16 splits a single waveguide input to multiple waveguide outputs such that the one sound signal from the driver 12 can be distributed to the plurality of waveguides 14a to 14b. It is an important property of the acoustic splitter 16 to retrain the acoustic impedance of the input for each of the n outputs in order to avoid waves being reflected towards the loudspeaker 12 which would otherwise interfere with its operation. A proper solution for achieving the acoustic impedance matching is that the cross-sectional area from the output of the driver 12 to the outputs of the splitter 16 is constant. Preferably but not necessary, the acoustic splitter 16 seals the loudspeaker driver space against the reproduction space such that just the soundwaves emitted through the waveguides 14a and 14b can reach the reproduction space 18. Optionally, the acoustic splitter 16 can be designed to feed different amounts of acoustic power to each of the individual outputs. All outputs of the acoustic splitter 16 are fed to individual waveguides 14a and 14b that serve two purposes:
First, to feed the acoustic power to the outlets 14a_o and 14b_o of the respective positions.
Second, to delay the acoustic waves such that the waves reach the outlets 14a_0 and 14b_0 with a suitable phase and magnitude to create the desired beam pattern.

The role of the outlets 14a_o and 14b_o is mainly determined by their positions which determine the radiation pattern in the reproduction space 18 in conjunction with the phase and magnitude of the waves fed to them. Additionally, the outlets 14a_o and 14b_o may be designed to match the acoustic impedance of the waveguides 14a and 14b to the acoustic impedance of the medium in the reproduction space 18.

Since now the fundamental structure of the loudspeaker 10 has been discussed, its functionality will be discussed.

The one driver 12 generates soundwaves which are fed via the acoustic splitter 16 to the at least two waveguides 14a and 14b. In other words, this means that the splitter 16 distributes the sound signal to the waveguides 14a and 14b which forward the received sound signal to its outputs 14a_o and 14b_o. The outputs 14a_o and 14b_o are arranged at different positions and form the transition to the reproduction space 18. Due to the distribution of the sound signal to different positions and due to the fact that the waveguide 14a and 14b enable a delay of the forwarded soundwaves which may differ from the first waveguide 14a to the second waveguide 14b a beamforming can be realized. Here, the beamforming is realized without signal processing, i.e., just by constant means. Consequently, it can be summed up that the shown loudspeaker 10 enables to distribute a sound signal to the outlets 14a_o and 14b_o arranged at different positions, wherein optionally and additionally a beamforming is enabled.

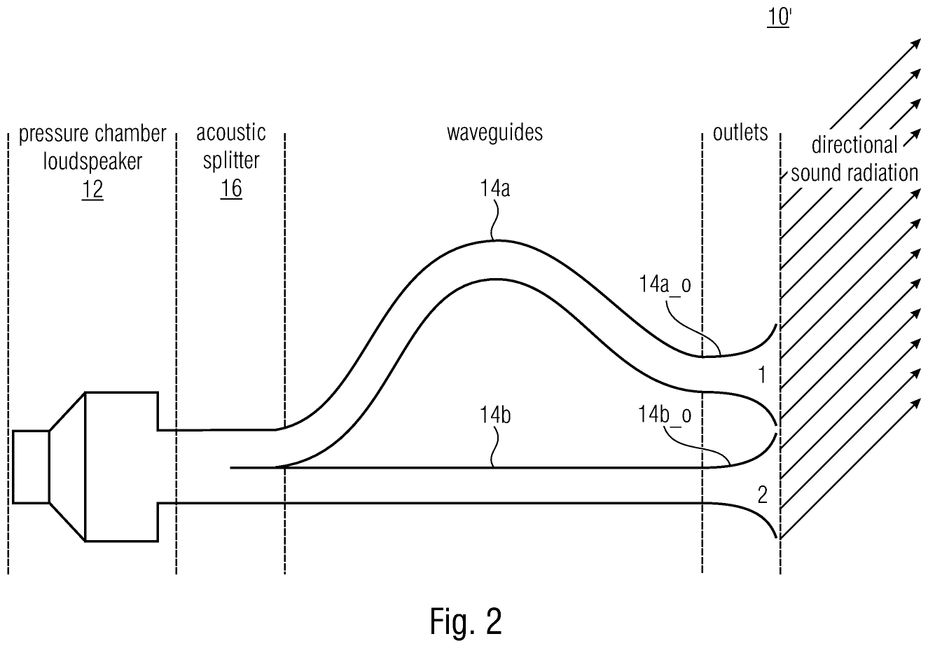

The embodiment of FIG. 1 can—expressed in other words—described as a single reproductive channel, e.g. comprising loudspeaker driver (and an optional DAC and amplifier) for beamforming. The presented method comprises coupling a single loudspeaker driver 12 to multiple waveguides 14a, 14b. Each of these waveguides 14a, 14b is designed to apply at least a specific delay and possibly further modifications to the guided wave before it reaches an outlet 14a_o, 14b_o at a specific position. In this way, a certain class of filter-and-sum beamformers can be realized. The outlets 14a_o, 14b_o, the waveguides 14a, 14b, and all connecting elements 16 can be manufactured using inexpensive materials. Since the invention only prescribes the position of the outlets 14a_o and 14b_o with respect to each other: the outlets 14a_o and 14b_o are, for example, arranged side by side and such that same are directed into the same direction so as to emit sound waves in parallel. Due to this positioning and the properties of the waveguides—e.g. their lengths (for example the waveguides 14a, 14b may have a length comparable to the wavelength of the desired frequency range) or its ability to delay the sound waves—acoustic beamforming can be realized, wherein teachings disclosed herein leave many degrees of freedom regarding the shape of the waveguides 14a, 14b and outlets 14a_o and 14b_o. Note, the loudspeaker 10 can be implemented in environments with strict space constraints. Different implementations of the loudspeaker 10 will be discussed below referring to FIGS. 2, 4 and 6.

FIG. 2 shows an embodiment of a loudspeaker 10′ having a pressure chamber loudspeaker driver 12, two waveguides 14a and 14b, each waveguide 14a and 14b coupled to a respective output 14a_o and 14b_o which are arranged side by side. For example, the two outlets 14a_o and 14b_o may comprise or may be formed as means for an enabling an impedance matching between the reproduction space and the waveguides 14a and 14b. Therefore, the outlets 14a_o and 14b_o may be formed as horn-shaped elements. Alternatively, horn-shaped elements or other elements enabling an impedance matching may be attached to the output of the waveguides 14a and 14b.

The two waveguides 14a and 14bare coupled to an acoustic splitter 16 connecting the waveguides 14a and 14b with the pressure chamber loudspeaker 12.

The embodiment of FIG. 2 with the two outlets 14a_o and 14b_o, which is the minimum possible number for a functioning implementation, enables a directional sound radiation as illustrated by the arrows. The two outlets 14a_o and 14b_o are positioned in the reproduction space in a distance lower than half of the wavelength with respect to each other, considering the frequency range of interest. It should be noted that the frequency range of interest may be 20 Hz to 20 KHz or 40/100/200/400/1000 Hz to 16/20 KHz and is typically defined by the limited bandwidth of the audio signal.

The waveguide connected to the outlet 14a_o is longer than the waveguide 14b connected to the outlet 14b_o. Hence, the acoustic wave radiation by outlet 14a_o is delayed in comparison to the wave radiated by the outlet 14b_o. It should be noted that both waveguides 14a and 14b received the same signal since the acoustic splitter 16 distributes the acoustic power uniformly to both waveguides 14a and 14b, wherein, due to the different design of the waveguides 14a and 14b, the soundwave output by the outlet 14a_o and 14b_o can differ from each other, e.g., with respect to its delay or its magnitude or its phase.

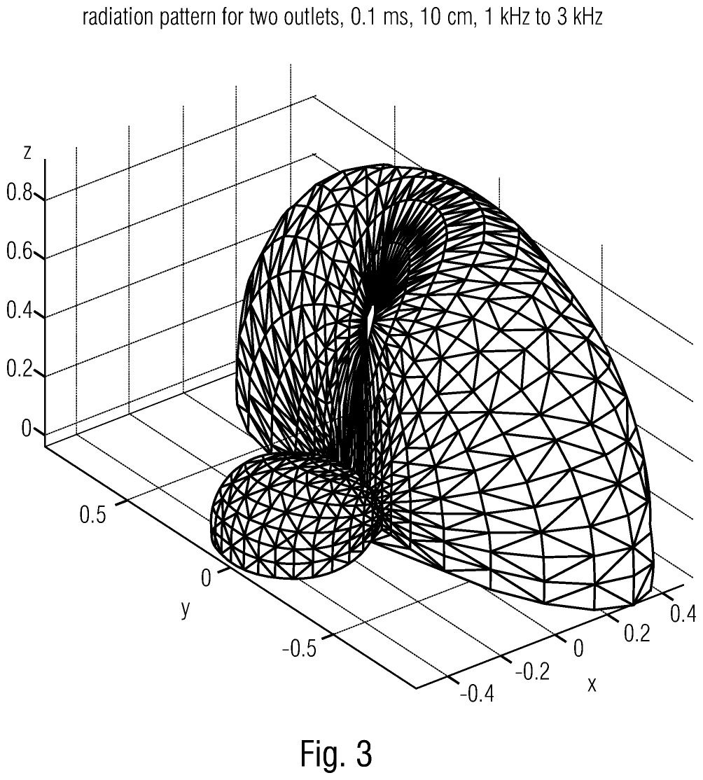

Regarding the loudspeaker driver 12, it should be noted that the properties of same are of minor importance. Also, the longitudinal cut shown in FIG. 2 is a two-dimensional drawing, the radiation pattern in a reduction space is dependent on three-dimensions. For this description, the radiation pattern of the outlet 14a_o and 14b_o is assumed to be sufficiently approximated by an ideal point source, where the array axis goes through the positions of both outlets 14a_o and 14b_o. The resulting radiation pattern would be rotational symmetry, where the maximum is not normal to the area axis but tilted towards outlet 14a_o. A computer simulation of the resulting radiation pattern is shown in FIG. 3.

The simulation of FIG. 3 starts from the assumption that the outlets 14a_o and 14b_o are positioned at ±5 cm on the x axis, the delay difference due to the waveguides is 0.1 ms, length difference 3.44 cm (and the distance of the surface to the order shows cumulative radiation power between 1 KHz and 3 KHz (an exemplary wavelength of interest).

Although using two outlets 14a_o and 14b_o is the simplest possible embodiment of this invention, using more outlets will be desirable in practical applications, wherein the three or more outlets may be arranged as a line array or may be arranged as a two-dimensional array in order to enhance the beamforming ability to a second dimension. More outlets will increase directivity, while the individual outlets are extremely inexpensive to manufacture at the same time.

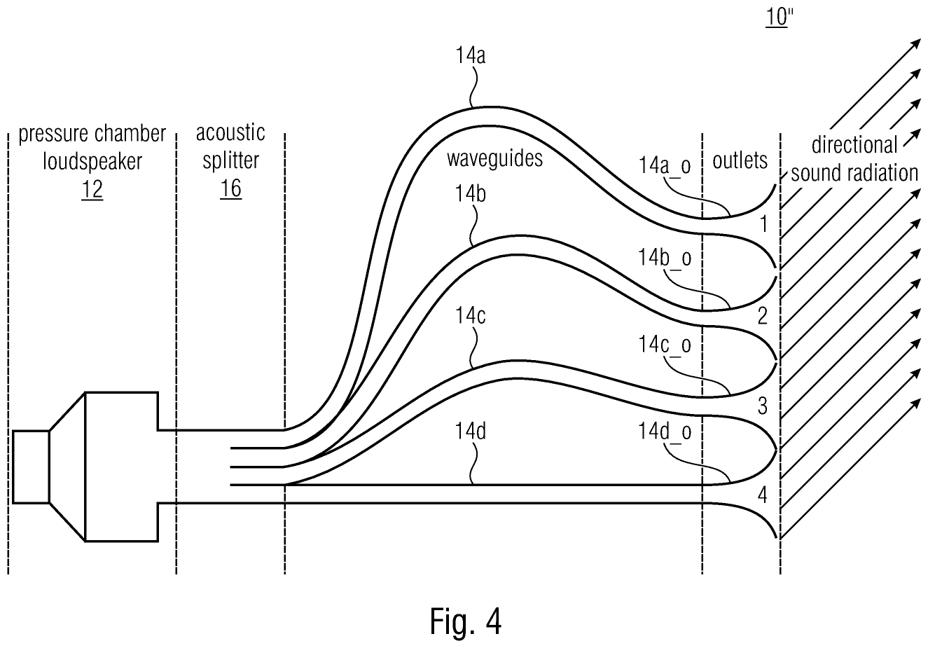

An example with four outlets is shown by FIG. 4. FIG. 4 shows a loudspeaker 10″, wherein the lengths of the waveguides are linearly decreased from outlet 1 to outlet 4 (cf. reference numeral 14a_o and 14d_o).

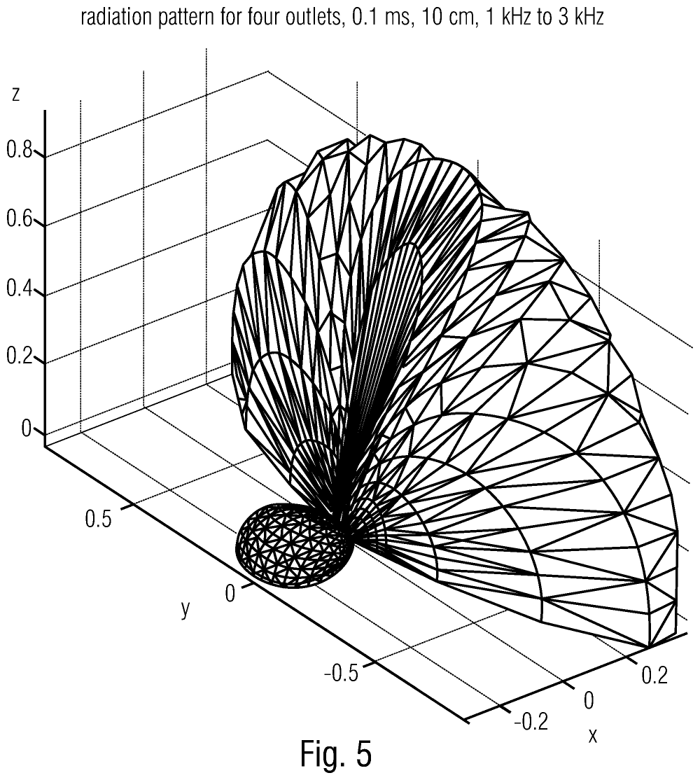

As can be seen by FIG. 5, the radiation pattern is similar to the case presented with respect to FIG. 2 and FIG. 3 but exhibits a higher directivity. It should be noted that the radiation pattern of FIG. 5 is simulated based on the assumption that the outlet 14a_o to 14d_o are aligned on an x axis with 10 cm spacing in between, where outlet 14a_o is on the positive x axis. The relative delays for the outlets 1 to 4 are 0.3, 0.2, 0.1 and 0 ms, respectively.

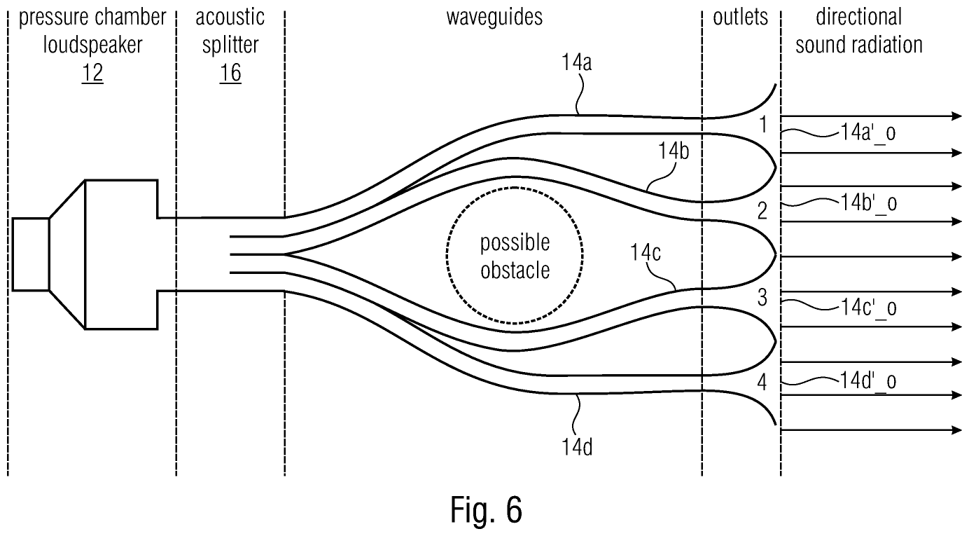

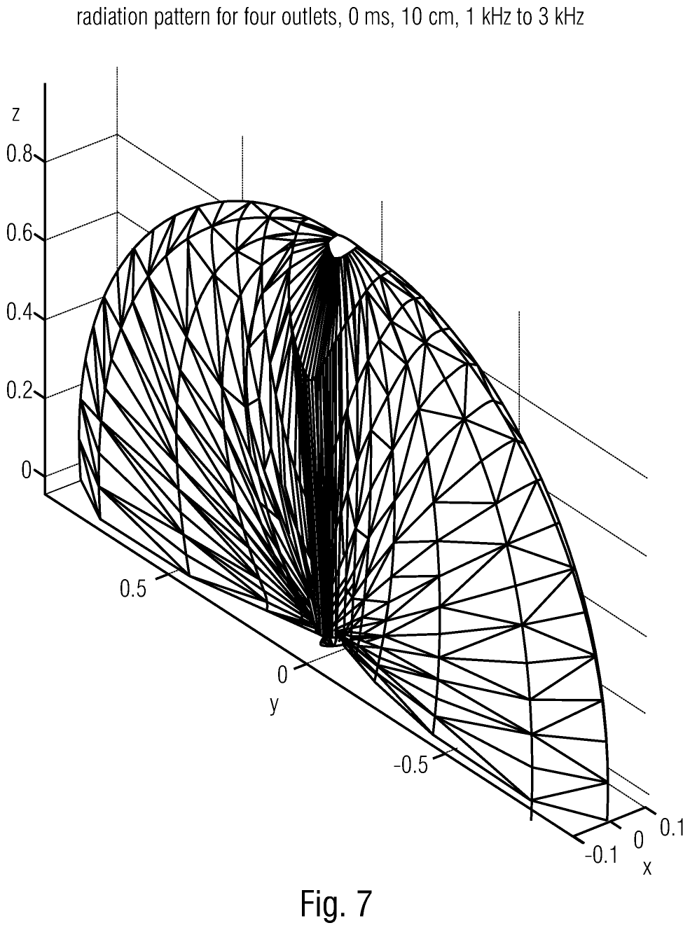

FIG. 6 shows a loudspeaker 10″′ also having the four outlets 14a′_o to 14d′_o, wherein the waveguides 14a′ to 14d′ leading to the four outlets 14a_o to 14d_o are of identical length. The resulting radiation pattern normal to the array axis is shown by FIG. 7.

FIG. 6 shows another advantage of the invention: Since the shape of the individual waveguides 14a′ to 14d′ can be chosen almost arbitrarily and they do not need to be adjacent to each other, it is possible to circumvent constructional obstacles without further ado. Here, it should be noted that the waveguide 14a′ to 14d′ may be performed by a flexible tube or a PVC tube which can be formed arbitrarily. The possibility to circumvent constructional obstacles, the above described context may be advantageously used for applications, where the space for certain components is already defined by passing or other components is typical for automotive applications or consumer electronics.

The design of the individual components, especially of the loudspeaker driver, waveguides, acoustic splitter and the outlets, will be discussed below in detail.

While, this invention is concerned with directional audio reproduction, while the loudspeaker driver comprised in this invention has practically no influence on the spatial properties. However, it has an influence on the spectral characteristics of the reproduced sound and therefore on the reproduction quality. As a consequence, not all loudspeaker drivers are equally well suited for application, here. Pressure chamber loudspeakers are designed to be attached to a waveguide or, in the case considered here, an acoustic splitter. Hence, they are ready-to-use components for this scenario. Nevertheless, this does not disqualify loudspeaker drivers that were designed for other purposes. When considering the well-known Thiele-Small parameters for electrodynamic transducers, a typical recommendation is to choose Qₘₛ relatively high and Qₑₛ relatively low such that the resulting Qₜₛ is in between 0.2 and 0.3 for horn-loaded driver. The same recommendation applies here.

The purpose of the acoustic splitter is to distribute the acoustic energy coming from the loudspeaker driver to the individual waveguides, avoiding backward reflections of the acoustic waves or a load mismatch with the loudspeaker driver. A simple way to achieve this is to retain the overall cross-sectional area normal to the wave-traveling direction over the whole length of the splitter, where the acoustic splitters in FIGS. 2, 4 and 6 are prototypical examples of such a component. Such a splitter retains the acoustic impedance from the input to the outputs. In general, the acoustic splitter may also be built to transform the acoustic impedance, as long as the input impedance matches the requirements of the loudspeaker driver.

It is well-know that the sidelobes of a beamformer can be controlled by weighting the power radiated by the individual array elements. In the case of this invention, this can be facilitated by weighting the acoustic energy radiated by the individual outlets. However, it would not be suitable if an outlet would absorb or reflect acoustic power. Hence, the weighting of the outlet power should already be facilitated by the acoustic splitter, e. g., with outputs of different diameters.

The waveguides determine the spatial radiation pattern and are therefore one of the most important components of this invention.

These waveguides will typically exhibit a tube-like shape, where the two transversal dimensions are smaller than half of the wavelength. Note that the length of the waveguides is typically not short compared to the wave length. Due to this geometry, only the 0-th order mode of the wave can propagate. This implies that each waveguide causes a delay of the wave that is only dependent on the length of the individual waveguide, but not on the wavelength of the actually guided wave. Thus, the length of the waveguide can be chosen to realize a delay-and-sum beamformer, when considering the known positions of the outlets. In this way, it is possible to choose the direction of a main beam in a broad frequency range and a null in a narrow frequency range. Furthermore, this geometry allows the waveguides to be built with an almost arbitrary curvature. This allows to fit the invention into a large variety of volume shapes, even those with intersecting obstacles. The actual tube-like shape can also be arbitrary due to the fact that only the 0-th order mode is propagating. Since the waveguides do not have to be aligned, their length is independent of the distance from the acoustic splitter to the outlets. This is, e.g., used for the arrangement shown in FIG. 6, where all waveguides exhibit the same length, although the distances of the acoustic splitter to the outlets differ.

When more advanced beamforming techniques should be realized, the waveguides can be designed in a slightly different way by adding cavities, side branches, connections between the individual waveguides, or similar structures. In principle, this allows to implement a wide range of passive filters, where many of the techniques known for waveguide filters (for electromagnetic waves) can be applied. However, acoustic waves can fulfil some boundary conditions that electromagnetic waves cannot fulfil, which precludes the use of some particular techniques that are applicable to electromagnetic waves. Note that these filter elements may possibly allow modes above 0-th order to propagate, in contrast to the simple waveguides described above.

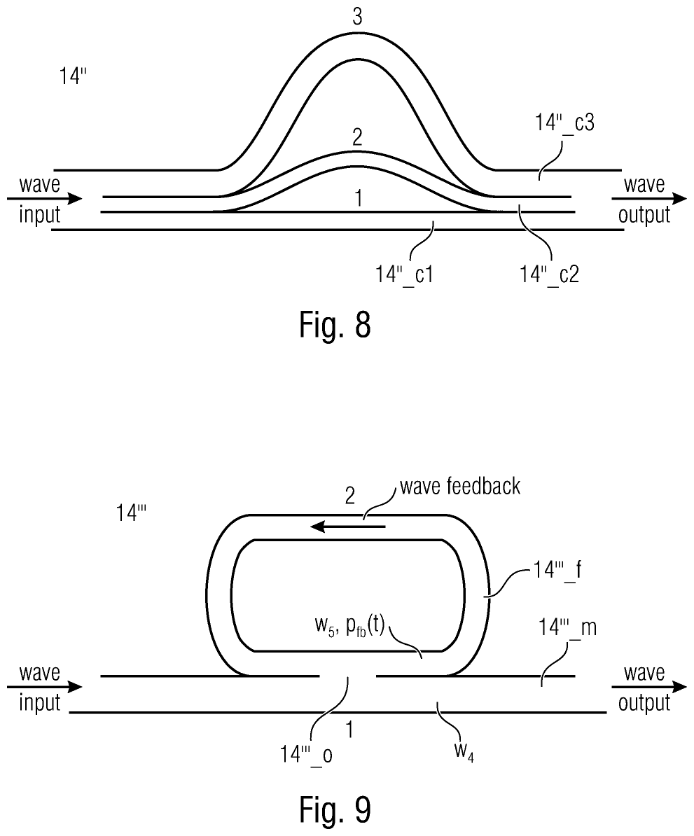

An example of a filter element that can be included in a waveguide is shown in FIG. 8, which would have the same effect as a simple finite impulse response (FIR) filter. FIG. 8 shows a waveguide filter element equivalent to a digital FIR filter, wherein the waveguide 14″ forming the filter element comprises three channels 14″_c1 to 14″_c3.

The three channels 14″_c1 to 14″_c3 have a different diameter when compared to each other. The elements distributes the power of the incoming wave to three smaller waveguides, numbered with 1, 2, and 3. Since the waveguides are of different length, the associated delays differ, which are denoted by t1, t2, and t3, respectively. Moreover, the waveguides exhibit different diameters, which implies that they carry a different amount of energy, when excited by an impulse. This amount of energy is described by amplitude weights w1, w2, and w3, respectively. When defining pin1(t) as the sound pressure of an input sound wave, the output wave would be given by

pₒᵤₜ₁(t)=Σₖ₌₁³wₖpᵢₙ₁(t−tₖ), (1)

which describes exactly the convolution with a FIR. However, the element is passive, which implies that

Σₖ₌₁³wₖ≤1, (2)

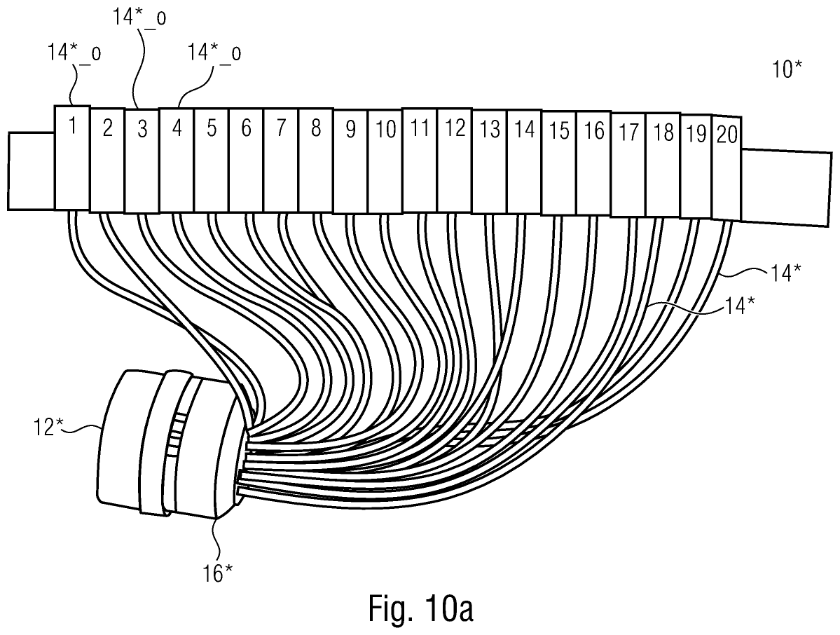

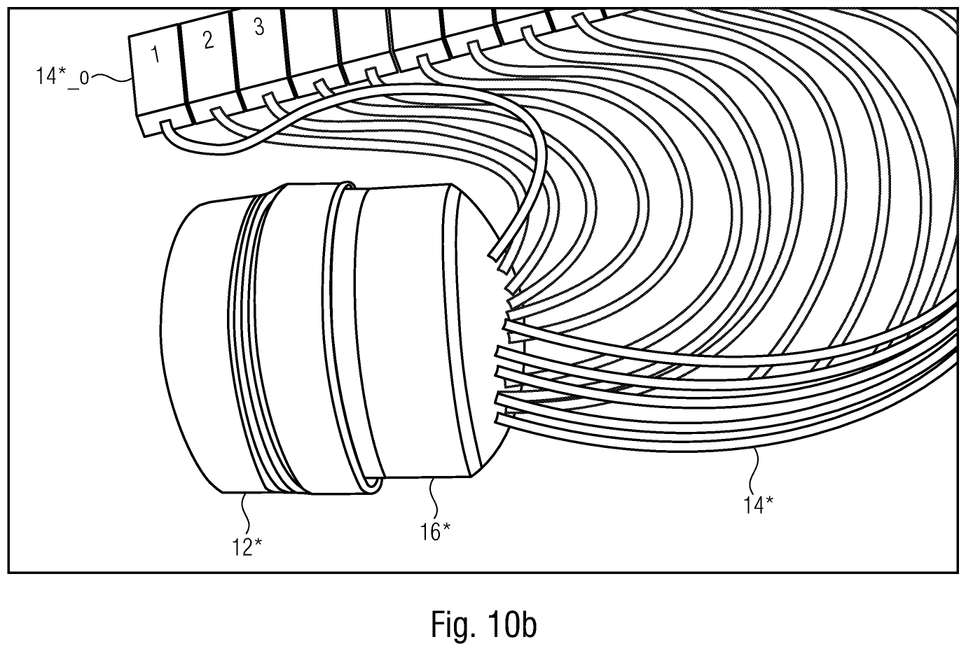

An alternative form to implement a filter element is shown in FIG. 9, where a part of the wave is fed back. FIG. 9 shows a waveguide 14″′ having a feedback loop 14″′_f. The feedback loop is arranged in parallel to the main channel 14″_m and coupled to the feedback loop 14′″_f via an opening 14″_o. It should be noted here that the opening 14″′_o serves the purpose as inlet and as outlet for the feedback loop 14″′_f. According to further embodiments, a plurality of openings for the inlet and for the outlet may be used.

The sound pressure of this wave is denoted by pfb(t). In the following, it is assumed that the delay of a wave traveling from the input to the output is given by t4, the delay of the feedback path is t5, and that the feedback waveguide is attached to the middle of the input-to-output path. It is furthermore assumed, that the aperture of the feedback waveguide is proportional to w5 and the aperture of the output waveguide is proportional to w4 and reflected waves due to impedance steps are disregarded. Then, the sound pressure at the output is given by

pₒᵤₜ₂(t)=w₄(pᵢₙ₂(t−t₄))+p_{fb}(t−t₅−t₄/2)), (3)

where

p_{fb}(t)=w₅(pᵢₙ₂(t−t₄/2)+p_{fb}(t−t₅)), (4)

An explicit expression for pout2(t) can be given, when transforming the equations to the frequency domain, where ω denotes the angular frequency and j is the imaginary unit:

Pₒᵤₜ₂(w)=w₄(Pᵢₙ₂(w)e^{-jωt}^{₄}+P_{fb}(w)e^{-jω(t}^{₅}^{+t}^{₄}^{/2)}), (5)

P_{fb}(w)=w₅(Pᵢₙ₂(w)e^{-jωt}^{₄}^{/2}+P_{fb}(w)e^{-jωt}^{₅}), (6)

Then, the system of equations can be resolved to

$${P}_{out 2} ( w ) = {P}_{in 2} ( w ) \underbrace{{w}_{4} ( {e}^{- {jwt}_{4}} + {w}_{5} \frac{{e}^{jw ( {t}_{5} + {t}_{4} )}}{( 1 - {w}_{5} {e}^{- {jwt}_{5}} )} )}_{H ( jw )} , \qquad ( 7 )$$

where H(jω) describes the frequency response of the waveguide filter. A further alternative is the use of a waveguide stub filter, which is not discussed here because it is widely treated in the literature.

The purpose of each single outlet is to match the acoustic impedance of the waveguide to the acoustic impedance of the air in the reproduction space. Besides that, the outlets have individual positions relative to each other in reproduction space. These, together with the delay discussed in the previous section, determine the radiation pattern of the beamformer. The actual shape of a single outlet is of minor importance. Possible shapes include, but are not limited to, circular, rectangular, or slit-like shapes. The aperture dimension of a single outlet is typically smaller than half the wavelength in the frequency range of interest.

One way to match the acoustic impedance is to use a small horn as an outlet, like it is depicted in FIGS. 2, 4, and 6. This is a very common solution due to its almost ideal properties. Another solution would be to extend the waveguide into open space and place a slit on the side of the extension to release the acoustic power of the wave with traveling length in the extension.

The positions of the outlets can be chosen according to the array geometries typically used in beamforming. The largest distance between two outlets is typically larger than the wavelength in the frequency range of interest. When aliasing is not acceptable, the distance between two outlets have to be smaller than half a wavelength. If the sidelobes due to aliasing do not interfere with the application, this requirement can be dropped. A simple prototype array geometry would be a linear array, which can be used to create rotational symmetric beam patterns. However, the presented approach is independent of the array shape. It is straightforwardly possible to implement a planar array using a two-dimensional outlet distribution, such that the beam direction can be chosen in two dimensions. In such a configuration, the economical advantages of the presented approach will be even more evident since a planar array would otherwise involve a huge number of relatively expensive transducers. In general, the surface where the outlets are positioned at does not need to be flat. Hence, the outlets could, for example, also be positioned sampling a hemisphere. It is also possible to realize less common array shapes like a curved linear array. Note that due to the fact that each outlet is fed by an individual waveguide, the outlet positions can be chosen arbitrarily. This is a substantial difference to acoustic lens based approaches, which are constrained to connect a (possibly intersected) single input aperture to a (possibly intersected) single output aperture.

Note that the same set of outlets can be used to steer multiple beams of independent signals, when an additional driver-splitter-waveguides combination is used per independent signal.

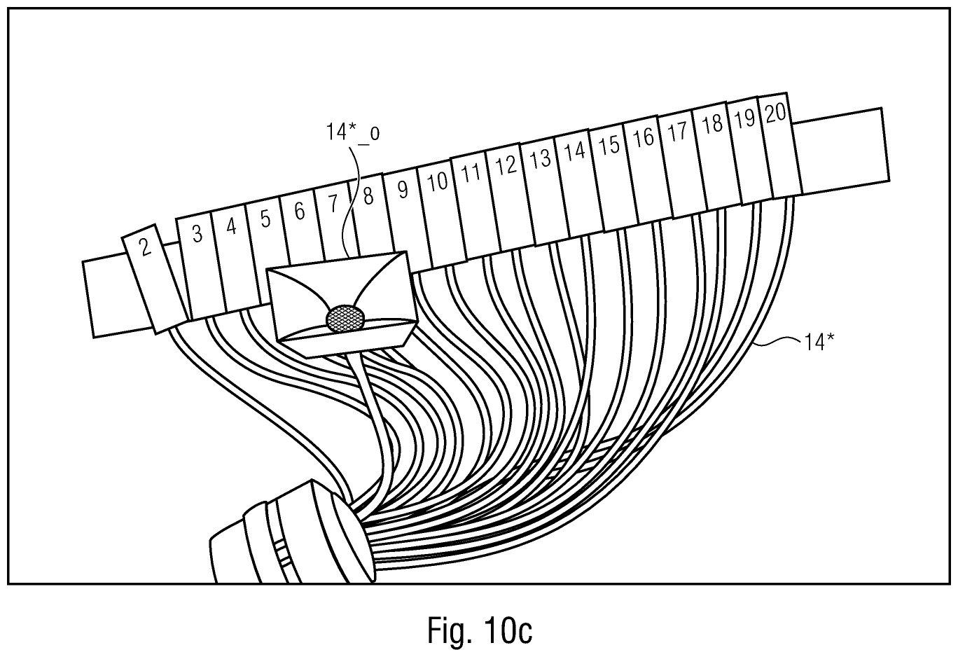

FIGS. 10a to 10c shows three different perspectives to a loudspeaker 10* having a single driver arranged within the loudspeaker chamber 12* which is coupled to a plurality of waveguides which are marked by the reference numeral 14*. Each of the plurality of waveguides is formed by a flexible tube, e.g., having an inner diameter of 12 mm² (5-25 mm²). The plurality of the tubes 14″ are coupled to the driver 12* in the area marked by the reference numeral 16* (e.g. acoustic splitter with identical the cross-sectional area of the input and the outuputs, as described above). Within the area 16* a transition from the outlet of the driver 12* to the plurality of waveguides 14* is made, wherein the plurality of tubes 14* are collected to a bundle, while the bundle is sealed against the surrounding.

As can be seen by FIG. 10c, the outlet of each waveguide 14* is formed by a horn 14*_o which is built as a separate entity and attached to the respective waveguide 14*. All horns 14*_o or, in general, all outlets 14* can be arranged such that same direct into the same direction. Consequently, the sound emitting directions of the plurality of outlets 14*_o are parallel to each other, wherein due to the combination of the soundwaves emitted by the plurality of waveguides 14*/outlets 14*_o the directivity pattern can be generated, as described above. As can further be seen by FIG. 10a, all outlet horns are arranged in series so as to form an array.

As discussed with respect to the other embodiments, it is also sufficient for the loudspeaker 10* to use a single loudspeaker driver or at least a loudspeaker arrangement driven by a single individual steered signal. The soundwave originating from the driver 12* is distributed to multiple individual waveguides 14* in the area 16*. The waveguides feeding to an individual outlet 14*_o at chosen positions 14* are primarily designed to delay the wave guided through them. The delays are determined such that the superposition of the soundwaves radiated by all outlets 14*_o results in the desired spatial reproduction pattern. An implementation according to these properties already allow for a considerably powerful implementation. The fact to be considered: Optionally, the waveguide 14* can be designed not only to delay but also to filter the waveguides through them as discussed with respect to FIGS. 8 and 9.

According to further embodiments, the waveguides can be constructed independently of each other. This means especially that their function is independent of a common housing or an adjacent arrangement although they can share a common housing and be arranged adjacently.

The length of the waveguides 14* is, according to embodiments, typically not small compared to the wavelengths in the frequency range of interest. However, the cross-section of the waveguides may typically be smaller than half of the wavelength and frequency range of interest.

As illustrated by FIGS. 10a and 10c, the outlets 14*_o are separable. Hence, they do not need to be in an adjacent arrangement but can be. This implies that the apertures of the outlets 14*_o can be interpreted as separate apertures. The dimension of an individual outlet 14*_o may, according to embodiments, typically be smaller than half of the wavelength in a frequency range of interest. The largest distance between two outlets 14*_o may typically be larger than the wavelength in the frequency range of interest. Using two waveguides 14* and outlets 14*_o, respecitvely, is the functional minimum, where more than two outlets will typically be used to achieve a sufficient directionality.

The above concept is applicable to any field, where the directional audio reproduction is needed. The two main advantages are low cost and large flexibility in the design. Hence, the invention is especially suited for application in consumer electronics or in automotive scenarios. There, the economical pressure is high such that all components have to be extremely low cost. Additionally, the shape of components suitable for such scenarios is already predetermined by the design of a consumer electronics device or the design of a vehicle interior. This emphasizes the importance of a flexible design.

Furthermore, all parts of the invention with exception of the loudspeaker driver can be manufactured without metallic components. This allows to use the invention for directional audio reproduction in environments where metallic components are not allowed, such as the inside of magnetic resonance imaging (MRI) devices. In that case, the loudspeaker driver would be positioned outside this environment, while the waveguides would guide the sound to the outlets inside this environment.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] O. Kirkeby and P. Nelson, “Reproduction of plane wave sound fields,” The Journal of the Acoustical Society of America, vol. 94, no. 5, p. 2992, 1993.
[2] M. Poletti, “An investigation of 2-d multizone surround sound systems,” in Proceedings of the Convention of the Audio Engineering Society, October 2008.
[3] Y. Wu and T. Abhayapala, “Spatial multizone soundfield reproduction: Theory and design,” IEEE Transactions on Audio, Speech, and Language Processing, vol. 19, no. 6, pp. 1711-1720, 2011.
[4] L. Bianchi, R. Magalotti, F. Antonacci, A. Sarti, and S. Tubaro, “Robust beam-forming under uncertainties in the loudspeakers directivity pattern,” in Proceedings of the IEEE International Conference on Acoustics, Speech and Signal Processing (ICASSP), 2014, pp. 4448-4452.

1. A loudspeaker, comprising:
one or more drivers arranged to emit sound waves;
at least two waveguides coupled to the one or more drivers to receive the sound waves emitted by the one or more drivers;
wherein the first of the at least two waveguides has an output positioned at a first position of the loudspeaker and is configured to forward the received sound waves to the output at the first position, wherein a second of the at least two waveguides has an output positioned at a second position of the loudspeaker and is configured to forward the received sound waves to the output at the second position;
wherein each of the at least two waveguides comprise a cross-sectional dimension which is smaller than the half of the wavelength of the sound waves to be transmitted and wherein a length of one of the at least two waveguides is at least as long as the half of the wavelength of the sound waves to be transmitted.

2. The loudspeaker according to claim 1, wherein the loudspeaker comprises just one driver.

3. The loudspeaker according to claim 1, wherein the loudspeaker comprises an acoustic splitter arranged between the one or more drivers and the at least two waveguides, wherein the acoustic splitter comprises one input and at least two outputs for the at least two waveguides and is configured to split the sound waves received on the input to the two outputs.

4. The loudspeaker according to claim 3, wherein the acoustic splitter comprises one or more channels and wherein a cross-section of the one or more channels remains constant along the length of the splitter; and/or
wherein the one or more channels comprise a summed cross-section being at least as large as an output of the one or more drivers.

5. The loudspeaker according to claim 1, wherein the first of the at least two waveguides are configured to forward the sound waves with a first delay, wherein the second of the at least two waveguides are configured to forward the sound waves with a second delay, where the difference of both delays is chosen so as to perform beamforming.

6. The loudspeaker according to claim 1, wherein the first and/or the second of the at least two waveguides is configured to vary the phase of the sound waves to be forwarded and/or to vary the magnitude of the sound waves to be forwarded.

7. The loudspeaker according to claim 1, wherein the at least two waveguides comprise at its output unit for matching an acoustic impedance and/or a horn configured to match the acoustic impedance.

8. The loudspeaker according to claim 1, wherein the first position differs from the second position so as to form an array by the arrangement of the outputs of the at least two waveguides; and/or wherein the first position is spaced apart from the second position by a distance lower than the half of the wavelength of the sound waves to be forwarded by the at least two waveguides.

9. The loudspeaker according to claim 1, wherein the at least two waveguides comprises a third waveguide comprising an output position at a third position of the loudspeaker and configured to forward the received sound waves to the output at the third position; or
wherein the at least two waveguides comprises a third waveguide comprising an output position at a third position of the loudspeaker and configured to forward the received sound waves to the output at the third position; wherein the outputs of the at least three waveguides form a two-dimensional pattern.

10. The loudspeaker according to claim 1, wherein the one or more drivers are designed as pressure chamber drivers and/or are arranged within a common pressure chamber.

11. The loudspeaker according to claim 1, wherein the at least two waveguides comprise a tube or channel connecting an input of the respective waveguide with its output; and/or wherein the waveguide has a horn-shape waveguide output.

12. The loudspeaker according to claim 1, wherein each of the at least two waveguides comprises two transversal dimensions which are smaller than the half of the wavelength of the sound waves to be transmitted.

13. The loudspeaker according to claim 1, wherein the first of the at least two waveguides has a length which differs from a length of the second of the at least two waveguides.

14. The loudspeaker according to claim 1, wherein at least one of the at least two waveguides comprises a side channel or a feedback channel so as to form an acoustic filter.

15. An automotive sound system comprising a loudspeaker according to claim 1.
